(19) United States
(12) Patent Application Publication
(10) Pub. No.: US 2015/0304707 A1
(43) Pub. Date: Oct. 22, 2015

(54) HOME-HUB PRIVATE CLOUD

(71) Applicants: Dennis Vadura, Trabuco Canyon, CA (US); Wei Kang Tsai, Irvine, CA (US); Timothy Hayden Nelson, Orange, CA (US)

(72) Inventors: Dennis Vadura, Trabuco Canyon, CA (US); Wei Kang Tsai, Irvine, CA (US); Timothy Hayden Nelson, Orange, CA (US)

(73) Assignee: Badu Networks Inc.

(21) Appl. No.: 14/620,877

(22) Filed: Feb. 12, 2015

Related U.S. Application Data
(60) Provisional application No. 61/938,704, filed on Feb. 12, 2014.

(51) Int. Cl. H04N 21/436; H04N 21/2347; H04N 21/426; H04N 21/41; H04N 21/643

(52) U.S. Cl. CPC H04N 21/43615; H04N 21/4135; H04N 21/64322; H04N 21/42653; H04N 21/2347

(57) ABSTRACT

A method and system to architect a private cloud, called a Home-Hub system, so that a user is given sufficient control over data stored in a Home-Hub system over a home or small-business network. A Home-Hub system comprises a home or office network, and 2 types of devices directly attached to the network: Hub devices and Branch devices. A Hub device is a wireless access point and a storage node. A Hub device is a central node for data exchange in a home network. A Branch device is a terminal, relay or peer node.

A Hub or Branch device may contain a digital storage device, a wireless AP (access point) or terminal, a positioning device such as a global positioning system receiver, one or more (wireless or fixed-line) modems connecting to the Internet, a network digital video recorder, and software that provides data sync and data backup.

### CROSS REFERENCES TO RELATED APPLICATIONS

The present Application claims priority to U.S. Provisional Patent Application No. 61/938,704 filed on Feb. 12, 2014, which is hereby incorporated by reference in its entirety.

### FIELD OF THE INVENTION

The present invention relates to methods and systems for cloud computing, and in particular, to methods and systems that allow contents, applications, and services, to be available and accessible from any device, through the infrastructure of a private cloud or a home cloud.

### BACKGROUND OF THE INVENTION

At an unprecedented pace, cloud computing has transformed the way corporations and individuals use electronic technologies. The key feature that makes cloud computing a success is the concept of sharing reconfigurable and rapidly deployable resources (e.g., networks, storage, applications, and services). Today, the vast majority of deployments utilize a public cloud, in which the services are offered to the general public.

The next frontier for cloud computing is private clouds, in which the infrastructure is provisioned for exclusive use by a single organization. A special type of private clouds is the home cloud, in which the primary and substantial amount of storage is hosted in a physical device at home, and a significant portion of communication takes place in a home network (rather than routed over the internet backbone).

Even though both public clouds and home clouds are under the same heading of cloud computing, they are actually very distinct. In particular, the definition of the home cloud actually contradicts the definition of cloud computing by NIST (National Institute of Standards and Technology).

A key difference between a public cloud and a home cloud is that the home cloud serves only a limited number of users, while the public cloud is configured to serve all and any user that pays a fee, or has a free account. In a public cloud, all users share the infrastructure dynamically, and a single user does not have absolute control over the needed resources—as a result, the quality of user experience may suffer.

In a home cloud, an individual or a household owns the cloud resources—often the user and the owner are one and the same. Therefore, there is no reason for sharing resources with a large number of unrelated users. In a home cloud, as the RTT (round-trip time) is short for data transfer between 2 nodes attached to the same network, the user experience is better.

In addition, as the usual home user does not change his use pattern frequently, there is little or no need to reconfigure. As the user is often not skillful enough to reconfigure the cloud, reconfiguration is even undesirable. These reasons make the concept of virtualization, the key technique for the public cloud, useless for the home cloud.

Another key difference between the home cloud and the public cloud is data storage location. In a public cloud, a user puts some or all of his data in the cloud. As a result, sensitive or private data could be stored in remote (or even foreign) datacenters unknown to the data owner. For security and privacy reasons, users may prefer to have their private data stored at home where they have physical access.

It is well known that security and privacy protection in the public cloud is poor. The security threats have caused a heightened concern in the US and many nations. As a result, the computer industry has responded by creating the Cloud Security Alliance (CSA) to deal with the unabating threats.

The root cause of the public-cloud security threats is resource sharing through virtualization. With virtualization, the owner of private data has no knowledge and no control over where his data are stored. In addition, with mobile cloud computing, the number of attack (entry) points has increased exponentially. Today's cloud infrastructure is so complex and dynamic that a simple change in one area may lead to a conflict or a new security hole in another area.

The individual users have yet another problem relating to big personal data. As mobile devices such as smartphones and tablets are now adopted en mass, the amount of privately generated and consumable data has also increased exponentially.

As a result, a user now finds it increasingly difficult to access and interact with his personal data. There are at least 2 aspects of this interaction: sharing data, and syncing data. People take digital photos/videos and store them online for sharing with friends and family. Between work and home, professionals sync the data between their mobile devices and work computers (laptops or desktops).

As the data size becomes large, interacting with the data has become a cumbersome job. Sharing data within different contexts may require different apps, and probably different formats also. For example, sharing a photo with a group of friends may need one app (application) and one data format; but to share the same photo with a family member may need another app, and possibly another format.

Today, to share photos and videos, a user has least the following choices: Flickr, Shutterfly, Picasa, Snapchat, Facebook, and Google+. A fundamental problem is that these apps do not give the user enough control over his personal data. For example, Facebook will automatically transcode the photos uploaded to their sites, whether the user likes it or not. Since every vendor designs its app to prevent its users from jumping to a competitor app, a user has to take the pain to transfer or transform his data when he wants to switch from one app to another.

There is yet another difference between a home cloud and a public cloud—the home cloud owner is just a consumer; he is mostly interested in apps. Most likely, he is not tech savvy—he wants a simple, easy-to-use, and plug-and-play system. Therefore, a home cloud should be application-centric; the primary purpose of a home cloud is to provide an integrated platform for the most desired apps.

In the home, the most desired apps include home entertainment, which may comprise TV or Home Theater, Hi-Fi music, and gaming. Another group of apps is personal productivity, which may comprise emails, social networking, groupware, data backup, data sync, etc. Another group of apps is smart home, which may comprise energy management, home safety and security, health and wellness, convenience and automation, etc.

Therefore, a desirable home cloud system is both data-centric and apps-centric. The user should be given sufficient control over his data in the proper context of apps to enhance security, usability, and convenience. Such a home cloud simply does not exist today.

All the above-mentioned disadvantages and issues are all related to the lack of user control over his data. The technologies of the public clouds do not address these issues and cannot be migrated to the private clouds. For private clouds over a small-business network, similar disadvantages and issues also exist. Therefore, there is a need for new methods and systems for architecting a private cloud in a home or small-business office so that all or some of the disadvantages are mitigated.

### BRIEF SUMMARY OF THE INVENTION

It is therefore an object of the present invention to provide a method and system to architect a private cloud, called a Home-Hub system, so that a user is given sufficient control over data stored in a Home-Hub system over a home or small-business office network.

In accordance with one aspect of the present invention, a Home-Hub system comprises a home or office network, and 2 types of devices directly attached to the home or office network: Hub devices and Branch devices. A Hub device is different from a Branch device by being a wireless access point (AP) and a storage node. A Hub device is a central node for data exchange in a home network.

In accordance with one aspect of the present invention, a Branch device is one that functions as a terminal, a relay, or a peer node (in a peer-to-peer or ad-hoc network). In a Home-Hub system, every Hub device and optionally some Branches devices are installed with special Home-Hub operating system (OS) software.

In accordance with one aspect of the present invention, the Hub devices in a Home-Hub system together act as the control center of the system. There is always a single Hub device that serves as the master Hub to control all Hub devices in the same Home-Hub system. The master Hub may also serve as the gateway between the home cloud and the external network.

A Hub or Branch device may be implemented by integrating Hub or Branch functionalities into a common consumer or office electronic device in a home or a small-business office. These devices may include, but are not restricted to, TV sets, Wi-Fi APs, TV set-top boxes, game boxes, routers, switches, personal computers, or server computers.

In accordance with one aspect of the present invention, a Home-Hub app provides a user with the ability to automatically sync and backup all personal data stored in the Home-Hub system. Employing a universal data model, a Home-Hub app allows all copies of a data item stored in a Home-Hub system in possibly different formats, or at possibly different locations, to be synced with optional user inputs.

In accordance with one aspect of the present invention, one or more Home-Hub apps allow a user to specify or control the storage location, the security and privacy, the syncing, the backup, and the interaction, of his personal data stored in the Home-Hub system.

This Summary is provided to introduce a selection of concepts in a simplified form. The concepts are further described in the Detailed Description section. Elements or steps other than those described in this Summary are possible. The claimed subject matter is not limited to the implementations that solve any or all disadvantages noted in any part of this disclosure.

### BRIEF DESCRIPTION OF THE DRAWINGS

The above and other objects and features in accordance with the present invention will become apparent from the following descriptions of embodiments in conjunction with the accompanying drawings, and in which:

FIG. 1 depicts the configuration in a basic Home-Hub system, in which a TV is integrated with Hub functionalities to serve as the master Hub.

FIG. 2 depicts the configuration in another Home-Hub system, in which a TV is integrated with multiple modems and is connected with an external modem.

FIG. 3 depicts the data flow in a data sync operation between 2 Home-Hub systems.

### DETAILED DESCRIPTION OF EXEMPLARY EMBODIMENTS

A method and system to architect a private cloud, called a Home-Hub system, to allow a user to control, in a simple and flexible way, the storage location, the security and privacy protection method, the syncing, the backup, and the interaction, of personal data stored in a Home-Hub system over a home or small-business network.

In the rest of this specification, the terms “Home-Hub system” and “home cloud” are used interchangeably. Further, as a Home-Hub system can be deployed in a home or a small-business (SB) office, hereafter in this specification, the term “home” is meant to be “home or SB office.” Hereafter, a handset with an app that can interact with a Home-Hub system is referred to as an enabled handset.

A Home-Hub system comprises a home network, and 2 types of devices that are directly attached to the home network: Hub devices and Branch devices. A Hub device is a wireless access point (AP) and a storage node in a home cloud. A Hub device is a central node for data exchange in a home network. In many embodiments, the home network that supports a home cloud is a Wi-Fi network. However, the network may also employ a wired network, or a non-Wi-Fi wireless network. All Hub and Branch devices in a Home-Hub system are attached to the same home network.

A Branch device is one that functions as a terminal in a Home-Hub system. However, a Branch device can also function as a relay or a peer node (in a peer-to-peer or ad-hoc network). In many embodiments, special Home-Hub operating system (OS) software is installed on all Hub devices, and optionally on some Branch devices.

The Hub devices in a home cloud together act as the control center of the system. If there are 2 or more Hubs in a Home-Hub system, a Hub is elected, or designated by a user, as the master Hub to control all the Hubs in the Home-Hub system. The master Hub in a home cloud may serve as the gateway between the home cloud and the external network. If a home cloud is configured as a P2P (peer-to-peer) network, all Hub devices may serve as a gateway between the home cloud and the external network.

A Hub or Branch device may be implemented by integrating Hub or Branch functionalities into a common consumer or office electronic device in a home. These devices may include, but are not restricted to, TV sets, routers, switches, wireless APs, TV set-top boxes, home gateway nodes, game boxes, personal computers, and server computers. When a TV set is integrated with Hub functionalities, the integrated TV set is referred to as a Hub-TV. When a TV set is integrated with Branch functionalities, the integrated TV set is referred to as Branch-TV. In a similar manner, a Hub Wi-Fi router is a Wi-Fi router integrated with Hub functionalities. The integrated Hub or Branch functionalities may be implemented either in software or software-and-hardware.

A user interacts with a Home-Hub system through a special app installed on a user handset, a Branch device, or a Hub device. In many embodiments, a user interacts with a Home-Hub system through a Home-Hub user interface (UI). The UI may be installed on a handset, a Branch device, or a Hub device. In some embodiments, a Home-Hub UI for a network digital video recorder (NDVR) may be installed on a user handset.

According to one aspect of the current invention, a local-storage NDVR may be integrated as a component of a Home-Hub system. In the Home-Hub version of NDVR, TV shows are locally recorded and stored in a storage device within a Home-Hub system. A user watches and manipulates the recorded shows via the Home-Hub network, without storing or retrieving recorded shows through a public cloud.

In such a Home-Hub system, the NDVR control functions are implemented as an app on mobile handsets such as smartphones, tablets, or laptop computers. The Home-Hub NDVR allows multiple users of a private group (such as friends and family) to control video recording, playing, storing, sending, retrieving, relaying, or streaming. The Home-Hub NDVR may employ multiple storage devices and multiple display devices.

In a Hub or Branch device, the following components may be present: (1) a digital storage device; (2) a wireless AP or terminal; (3); a positioning device such as a GPS (global positioning system) receiver; (4) one or more (wireless or fixed-line) modems connecting to the Internet; (5) a NDVR; (6) software that provides data sync and data backup; (7) an OS (operating system) for a home cloud; and (8) a display unit. These 8 components do not have to be present together in a Hub or Branch device.

In accordance with one aspect of the present invention, a plurality of Home-Hub systems may form a Home-Hub community, in which a user of a said Home-Hub system is allowed to make use of designated shared infrastructure resources of a second said Home-Hub system in the community, while said shared infrastructure may comprise resources of hardware, software, storage, networks, applications, or services.

An important aspect of a Home-Hub community is storage sharing. Under a service-level agreement among the owners of multiple Home-Hub systems, data may be replicated in the storage facilities in one or more sharing Home-Hub systems. In a Home-Hub community, data stored in one Home-Hub system may be replicated and synced in a second Home-Hub system.

In accordance with one aspect of the present invention, a Home-Hub app provides a user the ability to automatically sync and backup all personal data stored in the Home-Hub system. The Home-Hub app may employ a universal data model that allows a data item to exist as an abstract object that is physically stored in possibly different formats, at possibly different locations, with possibly different names, for the purpose of different apps. A special Home-Hub app may provide a universal data sync as follows: using a universal data model, when one copy (in a specific format and at a specific location) of a data item is modified, all copies of the same data item are automatically synced, with optional user inputs.

When it is needed to transfer some data from one physical device to another physical device, and both devices are directly attached to the home network of a Home-Hub system, the data may be transferred only through the home network, without going through the Internet backbone.

In accordance with one aspect of the present invention, a Home-Hub app allows a user to specify or control the storage location, the security and privacy, and the syncing and backup, of his personal data, which is stored in the Home-Hub system. In some embodiments, a user is given the ability to designate a certain storage device in a Home-Hub system to be more secure than another storage device, or to be the location for certain designated data.

In a Home-Hub system, a user is allowed to create a customized data type for the purpose of security and privacy, allowing all data of a said customized data type to be stored with special restrictions, or in designed storage devices. A user may specify the access restrictions for his private data, with or without customized data types. For example, a user may create a custom data type so that all items of this type are stored in a designated Hub device with a special 128-bit encryption scheme.

In some embodiments, a Home-Hub user may designate some data to be of 3 types: (1) private data, (2) shared data, and (3) public data. Further, a data item can be both private and shared. In a Home-Hub system, private data may be stored with encryption and may be sent over the Internet only in encrypted formats.

To access shared data, a user has to be authorized or granted the access rights from the owner of the shared data. In a Home-Hub system, public data are accessible by any user that employs the Home-Hub system to retrieve the data.

Optionally, when an app requests to access private data stored in a Home-Hub system through the Internet, the requested private data may be sent over the Internet only in encrypted formats.

Optionally, a Home-Hub-system provides an API (Application Program Interface) or inter-app software mechanism (such as the Intent facility in the Android system) to allow 3^{rd}-party apps to utilize the native services provided by the Home-Hub system OS. Services provided by a Home-Hub OS may include data sync, data backup, data transfer, data security, and data secrecy (privacy).

A Hub-TV system is a special type of a Home-Hub system, in which a Hub-TV serves as the master Hub.

In some embodiments, a Hub-TV system may be implemented to receive videos through as IPTV (Internet-Protocol TV) operator. In some embodiments, a Hub-TV set is integrated with an IPTV set-top box. In some embodiments, a Hub-TV is equipped to receive over-the-air terrestrial broadcast TV shows.

In some embodiments, a Hub-TV is integrated with a hybrid set-top box, which allows videos served from both non-IP sources (e.g., terrestrial broadcast, satellite, or cable) and IP sources (e.g., IPTV channels). A hybrid set-top box can either be integrated into a Hub-TV or be separately connected to a Hub-TV.

One use of a Hub-TV or Home-Hub system is to allow new entities to serve as an MSO (multiple system operator). In some embodiments, a mobile carrier is enabled to provide an IPTV service directly to the homes with a Hub-TV or Home-Hub system, in which a Hub device is integrated with a wireless modem that directly connects to the cellular network of the carrier. In other embodiments, an operator is enabled to provide an MSO service to homes with a Hub-TV or Home-Hub system, in which the operator is connected to the Home-Hub system through a network (wireless or fixed line) connection.

Another use of a Hub-TV or a Home-Hub system is to allow advertisements to be delivered through the Home-Hub infrastructure. In some embodiments, a commercial entity is enabled to deliver advertisements along with media items to consumers that use a Hub-TV or Home-Hub system.

In accordance with one aspect of the present invention, because of the heavy-duty workload in a Home-Hub system that streams videos, the Hub functionalities are implemented with a computing system having at least 16 GPU (graphics processing unit) cores.

A use case for a Hub-TV system is as follows. User 1 wants to watch Video 1 on a big-screen TV (which is the Hub-TV) in the living room, while User 2 wants to watch Video 2 on an alternate TV (which is the Branch TV) in Room 2, and User 3 wants to watch Video 3 on his tablet in Room 3. Video 1 is stored in a smartphone of User 1. The Branch-TV in Room 2 is able to receive Video 2 streamed directly from the Hub-TV in the living room. Video 2 is streamed from an MSO, but the modem is directly connected to the Hub-TV in the living room only. Video 3 is stored in the Hub-TV in the living room.

The 3 videos are served as follows: (1) Video 1 is streamed directly from the smartphone to the Hub-TV in the living room; (2) Video 2 is streamed from the MSO to the Hub-TV, and the Hub-TV acts as a relay to stream Video 2 to the Branch-TV in Room 2; (3) Video 3 is streamed directly from the Hub-TV in the living room to the tablet in Room 3.

All users—User 1, User 2, and User 3—may utilize a native Home-Hub app, such as a Home-Hub NDVR, or a 3^{rd}-party app that utilizes an API or communication facilities provided by the Hub-TV system, through their Hub-TV enabled handsets.

A second use case for a Hub-TV system is as follows. User 1 is staying in a hotel out of the country and wants to watch a TV show from his cable-TV service available at home. User 2 is in his office away from home; he wants to access a private file that he has stored in the Hub-TV. User 3 is at home and he wants to share a few photos with User 1 and User 2, who are not at home.

These Hub-TV services are provided as follows: (1) The requested TV show has been pre-recorded and stored in the Hub TV; User 1 receives (through streaming or download) the show on his handset in the hotel; (2) User 2 retrieves the private file from the Hub-TV, through the Internet, while the file is sent with encryption; (3) User 1 and User 2 have been pre-authorized by User 3; they receive the shared photos from User 3 through a Hub-TV or a Hub device via the Internet.

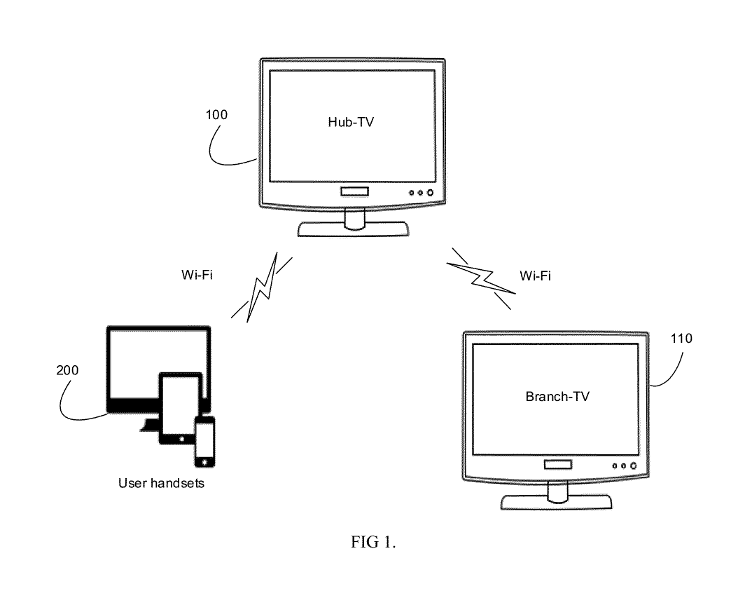

FIG. 1 depicts a basic home Hub system. The Hub device is a Hub-TV 100 and the enabled handsets 200 are laptops, tablets and smartphones. In this system, a Branch device is a Branch-TV 110. In this system, all devices in the system communicate over a Wi-Fi network.

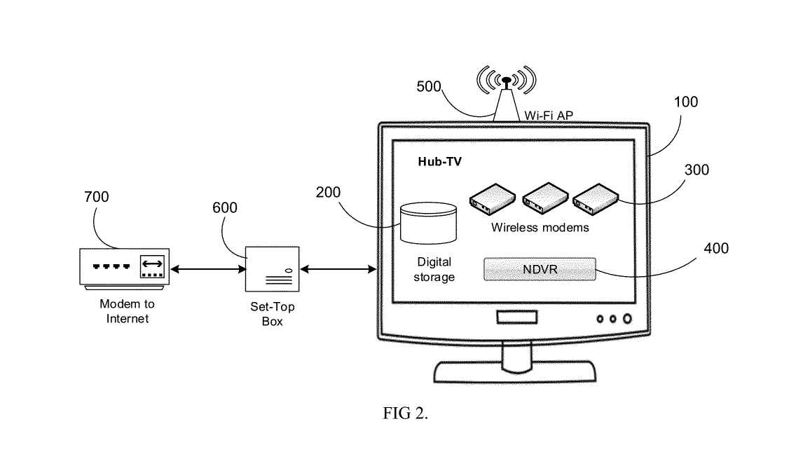

FIG. 2 depicts another Hub-TV system. In this system, an MSO modem 700 and an MSO set-top box 600 are located outside of the Hub-TV 100. 3 wireless modems 300 that connect to the Internet through 3 service providers are integrated within the Hub-TV 100. A storage device 200 and a soft NDVR 400 are also integrated within the Hub-TV 100. The Hub-TV 100 is also equipped with a Wi-Fi AP 500.

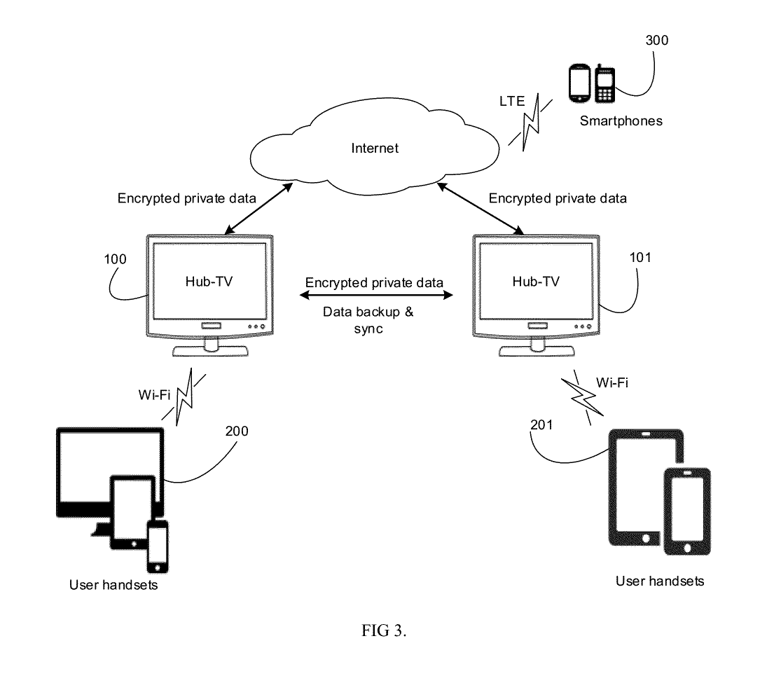

FIG. 3 depicts a use scenario for a Home-Hub system. A user accesses the data stored in 2 Hub-TVs in 2 different homes using smartphones 300 via an LTE (Long-Term Evolution) link. The data are stored in the Hub-TV 100 and replicated in Hub-TV 101. These 2 Hub-TVs are located in 2 separate homes; the 2 separate Home-Hub systems are synced through the data sync functions provided by the community Home-Hub system formed by the 2 Home-Hub systems. Within the 2 homes, user handsets (tablets, smartphones, laptops, etc.) 200 and 201 communicate with Hub-TV 100 and Hub-TV 101 via Wi-Fi. In the community Home-Hub system, all private data communications are encrypted.

What is claimed is:

1. A machine-implemented method to architect a private cloud, called a Home-Hub system, to allow a user to control the storage location, the security and privacy protection method, and the syncing, the backup, and the interaction, of personal data stored in a said Home-Hub system over a network in a home or a small business office, comprising:
a home or office network;
a plurality of Hub devices, all directly attached to said home or office network;
a plurality of branch devices, all directly attached to said home or office network;
wherein a said Hub device is both a wireless access point (AP) and a storage node; a said Branch device acts as terminals, or rely, or a peer node in said home or office network; all Hub devices together act as the control center for said Home-Hub system; special Home-Hub operating system (OS) is installed on all Hub devices, and optionally on some Branch devices.

2. The method of claim 1, wherein a Hub device or a Branch device may be implemented by integrating Hub or Branch functionalities into a common home or office electronic device, while these devices including, but not restricted to: TV sets, routers, switches, wireless APs, TV set-top boxes, home gateway nodes, game boxes, personal computers, and server computers.

3. The method of claim 2, wherein one or more of the following components may be present in a Hub or Branch device: (1) a digital storage device; (2) a wireless AP or terminal; (3); a positioning device such as a GPS (global positioning system) receiver; (4) one or more (wireless or fixed-line) modems connecting to the Internet; (5) a NDVR (network digital video recorder); (6) software that provides data sync and data backup; (7) an OS for a home cloud; and (8) a display unit.

4. The method of claim 3, wherein a Home-Hub system provides an API (application program interface) or an inter-app software mechanism to allow third-party apps to utilize the native services provided by the Home-Hub system OS, while said services provided by Home-Hub OS may include data sync, data backup, data transfer, data security, and data secrecy (privacy).

5. The method of claim 4, wherein a plurality of Home-Hub systems form a Home-Hub community, in which a user of a said Home-Hub system is allowed to make use of designated shared infrastructure resources of a second said Home-Hub system in the community, while said shared infrastructure may comprise resources of hardware, software, storage, networks, applications, or services.

6. The method of claim 5, wherein a Home-Hub app employs a universal data model to allow a data item to exist as an abstract object that is physically stored possibly in different formats, possibly at different locations, with possibly different names, for the purpose of different apps.

7. The method of claim 6, wherein all copies of the a single data item are automatically synced, with optional user inputs, when one copy (in a specific format and at a specific location) of said data item is modified.

8. The method of claim 5, wherein a user is given the ability to designate a certain storage device in a Home-Hub system to be more secure than another storage device, or to be the location for certain designated data items.

9. The method of claim 8, wherein a user is allowed to create a customized data type for the purpose of security and privacy, allowing all data of a said customized data type to be stored with special restrictions, or in designed storage devices; a user may also specify the access restrictions for his private data, with or without customized data types.

10. The method of claim 4, wherein the master Hub in a Home-Hub system is both a Hub device and a TV set.

11. The method of claim 10, wherein a Hub device in a Home-Hub system is integrated with an set-top box that allows said Hub device to receive terrestrial TV broadcast, satellite TV, cable TV, or IPTV (Internet Protocol TV) shows; wherein said set-top box may sit externally to the Hub-device.

12. The method of claim 10, wherein a Hub device is integrated with a wireless modem that directly connects to a cellular network, or a Hub device is connected to a multiple system operator through a wireless or fixed-line network connection.

13. (canceled)

14. The method according to claim 4, wherein a Hub device is implemented with a computing system having at least 16 GPU (graphic processing units) cores.
